(19) United States
(12) Patent Application Publication
(10) Pub. No.: US 2006/0238436 A1
(43) Pub. Date: Oct. 26, 2006

(54) Method for constructing microwave antennas and circuits incorporated within nonwoven fabric

(75) Inventors: Michael A. Deaett, North Kingstown, RI (US); William H. Weedon III, Warwick, RI (US); Terezie Zapletalova, Raliegh, NC (US)

Correspondence Address: MAURICE M. LYNCH, 429 CHURCH AVENUE, WARWICK, RI, 02885, US

(73) Assignee: Applied Radar

(21) Appl. No.: 11/113,222

(22) Filed: Apr. 23, 2005

(51) Int. Cl. H01B 3/44

(52) U.S. Cl. 343/897; 343/718; 174/110 R; 428/370; 29/600

(57) ABSTRACT

This patent describes fabric antenna and fabric microwave circuits and the method for making the same. Microwave conducting material is incorporated into non-woven fabrics using a calendaring process to produce an antenna or microwave circuits. The resulting material can then be manufactured into garments, either as filler material or as a garment itself The carrier fabric of these antennas also allows for said antennas to be flexible and allows for folding for storage. In the current state of the art, antennas are added to a garment during said garment's construction as opposed to incorporation into the fabric itself.

### BACKGROUND OF THE INVENTION

Microwave antennas are constructed today by using multilayer circuit board technology. These antennas can be inserted into garments only with difficulty and the resulting garment is uncomfortable to wear. Also, since the antenna is added during the garment manufacture, the cost is increased.

There is prior art in the area of fabric antennas. Van Heerden et al. in U.S. Pat. No. 6,677,917 describes a fabric antenna that consists of a radio frequency transponder and a radio frequency circuit enclosed in a housing and this is attached to conductive thread, glue and substrate. The antenna is enclosed in a seam of the garment. Van Heerden, in U.S. Pat. No. 6,686,038, describes a conductive fiber that is capable of being sewn, woven or knitted into a conductive mesh.

Another relevant patent is U.S. Pat. No. 6,433,743 by Massey et al. This describes a patch antenna that can be incorporated into a garment. The patch antenna comprises two spaced layers of electrically conductive fabric sandwiched around a non-conductive layer of fabric with a connection between the two conductive layers. The resulting patch is then incorporated into a garment.

GPS antennas have also been incorporated into garments, see Krasner U.S. Pat. No. 6,259,399. In this patent, the inventor describes an antenna “attached to the garment.” This is not the case in this application.

In this application, a non-woven fabric, a conductive fabric or a wire-mesh which is able to conduct microwave energy is used to make a patch antenna. Conductive non-woven fabric is a non-woven fabric that has incorporated a conductive metal. See U.S. Pat. No. 6,841,244 by Foss et al. This patent describes an anti-microbial fiber that contains an additive comprised of “a zeolite of a metal selected from the group consisting of silver, zinc, copper and tin.”

### SUMMARY OF THE INVENTION

The object of this invention is to describe a method for incorporating antennas, electronic filter components, and microwave circuits into woven and non-woven fabrics. In the preferred embodiment of this invention, a layer or layers of conductive fabric comprises the conductive material upon which microwave energy can be channeled producing an antenna, electronic filter components or microwave circuits. This conductive fabric is encapsulated or fused in layers of non-conductive fabric. Non-woven fabrics are broadly defined as sheet or web structures bonded together by entangling fiber or filaments (and by perforating films) mechanically, thermally or chemically. They are flat, porous sheets that are made directly from separate fibers or from molten plastic or plastic film. They are not made by weaving or knitting and do not require converting the fibers to yarn. Non-woven fabrics are engineered fabrics that may have a limited life, may be single-use fabric or may be a very durable fabric. Non-woven fabrics also provide specific functions such as absorbency, liquid repellency, resilience, stretch, softness, strength, flame retardancy, washability, cushioning, filtering, bacterial barrier and sterility.

### BRIEF DESCRIPTION OF THE DRAWINGS

FIG. 1 shows the calendaring process.

FIG. 2 shows a non-woven fabric incorporating an antenna patch made of a non-woven metalized fabric.

FIG. 3 shows a woven fabric incorporating an antenna with impedance matching circuit made of a non-woven metalized fabric.

### DETAILED DESCRIPTION OF THE DRAWINGS

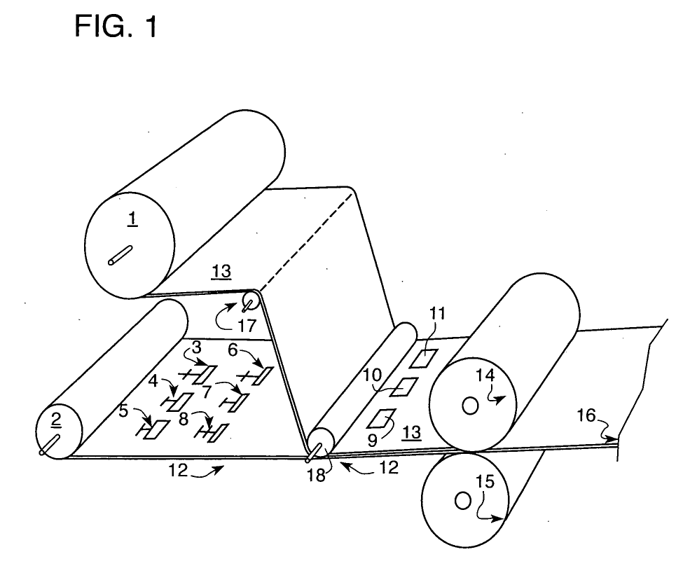

FIG. 1 shows a means for constructing multilayer antennas using a multiple raw mesh calendar, 14 and 15. This calendar produces the non-woven fabric, 16. Raw fibrous meshes are stored on rolls 1 and 2. The mesh of roll 1, labeled 13, is fed over the traveler roll 17 and down to traveler roll 18. The raw fibrous mesh, 12, is fed from the roller labeled 2 across a flat surface to the traveler roller labeled 18. During the motion of raw mesh 12 from roll 2 to roller 18 there is deposited onto mesh 12 by automatic means precut pieces of conductive fabric. These fabric pieces, 3,4,5,6,7,8 may be positioned to effect a precise alignment with fabric pieces 9,10 and 11. The later pieces 9,10,11 are automatically deposited onto mesh 13 after proceeding under roller 18. The calendar then applies pressure and heat to produce the composite fabric labeled 16.

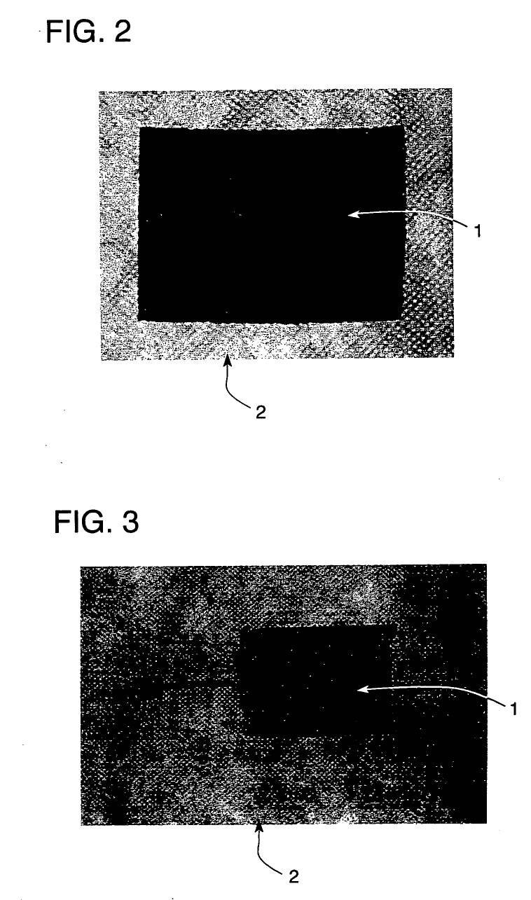

FIG. 2 shows conductive non-woven fabric 1 shaped as an antenna patch encapsulated in the non-conductive, non-woven fabric 2.

FIG. 3 shows conductive non-woven fabric 1 formed as an antenna with a matching circuit microwave circuit encapsulated in non-conductive, non-woven fabric 2.

We claim:

1. A fabric microwave antenna comprising:
at least one layer of non-conductive non-woven fabric to provide a flexible backing or carrier; and at least one layer of conductive non-woven fabric, woven fabric, conductive mesh, or conductive thread.

2. The fabrics are joined by a calendering method, said method comprising the steps of:
transferring a layer or layers of conductive non-woven fabric or any conductive fabric or mesh on which microwave energy can be channeled to a least one carrier non-woven fabric;
carrying said conductive non-woven fabric or conductive fabric or mesh on said non-woven carrier through a calender nip, said calender nip formed by a bottom and top calender roll;
the temperature in the top calender roll is maintained between 100 to 600 degrees Fahrenheit with an optimal temperature of 293 degrees Fahrenheit and the temperature of the bottom roll is maintained between 100 to 600 degrees Fahrenheit with an optimal temperature of 300 degrees Fahrenheit:
the pressure between the bottom and top calender rolls is maintained between 500 and 2000 pounds per square inch with an optimal pressure maintained at 1000 pounds per square inch.

3. The fabric antenna as claimed in claim 1, wherein said means for connection to said portable electronic device comprise one or more conductive press stud connectors or other connectors in electrical contact with the conductive element

4. Fabric microwave circuits comprising:
at least one layer of non-conductive non-woven fabric to provide a flexible backing or carrier; and at least one layer of conductive non-woven fabric, woven fabric, conductive mesh or conductive thread.

5. The fabrics are joined by a calendering method, said method comprising the steps of:
transferring a layer or layers of conductive non-woven fabric or any conductive fabric or mesh on which microwave energy can be channeled to a least one carrier non-woven fabric;
carrying said conductive non-woven fabric or conductive fabric or mesh on said non-woven carrier through a calender nip, said calender nip formed by a bottom and top calender roll;
the temperature in the top calender roll is maintained between 100 to 600 degrees Fahrenheit with an optimal temperature of 293 degrees Fahrenheit and the temperature of the bottom roll is maintained between 100 to 600 degrees Fahrenheit with an optimal temperature of 300 degrees Fahrenheit;
the pressure between the bottom and top calender rolls is maintained between 500 and 2000 pounds per square inch with an optimal pressure maintained at 1000 pounds per square inch.

6. The microwave circuit as claimed in claim 4, wherein said means for connection to said portable electronic device comprise one or more conductive press stud connectors or other connectors in electrical contact with the conductive element
